(19) United States
(12) Patent Application Publication
(10) Pub. No.: US 2025/0260124 A1
(43) Pub. Date: Aug. 14, 2025

(54) POWER STORAGE DEVICE

(71) Applicant: TOYOTA JIDOSHA KABUSHIKI KAISHA, Aichi-ken (JP)

(72) Inventors: Shigeyuki INOUE, Toyota-shi (JP); Kazuki SUGIE, Miyoshi-shi (JP); Yuki TAKAHASHI, Miyoshi-shi (JP)

(21) Appl. No.: 19/019,290

(22) Filed: Jan. 13, 2025

(30) Foreign Application Priority Data
Feb. 8, 2024 (JP) 2024-018030

(51) Int. Cl. H01M 50/30; H01M 50/209; H01M 50/317

(52) U.S. Cl. CPC H01M 50/394; H01M 50/317; H01M 50/209

(57) ABSTRACT

A power storage device includes a plurality of power storage stacks, a case, a pressure relief valve, and a breathable membrane. The case includes a bottom wall, a peripheral wall, and a top wall. The pressure relief valve is provided on the top wall. The breathable membrane is provided at a part of the bottom wall and the peripheral wall located below the pressure relief valve.

### CROSS REFERENCE TO RELATED APPLICATIONS

This nonprovisional application is based on Japanese Patent Application No. 2024-018030 filed on Feb. 8, 2024 with the Japan Patent Office, the entire contents of which are hereby incorporated by reference.

### BACKGROUND

### Field

The present disclosure relates to a power storage device.

### Description of the Background Art

For example, Japanese Patent Laying-Open No. 2023-47012 discloses a battery pack including a plurality of battery cells, a case that accommodates the plurality of battery cells, a pressure relief valve provided to the case, and a breathable membrane provided to the case. The case has a lower case and an upper cover. The pressure relief valve is provided to the upper cover, and the breathable membrane is provided to a side wall portion of the lower case.

### SUMMARY

In the battery pack described in Japanese Patent Laying-Open No. 2023-47012, when gas is generated from any of the battery cells and pressure in the case reaches a reference value, the gas is discharged through the pressure relief valve. Thereafter, air flows into the case through the breathable membrane to adjust the internal pressure in the case.

On this occasion, when a battery cell different from the battery cell that has previously generated the gas generates heat, the air flowing into the case through the breathable membrane may come into contact with that battery cell and thereby heat generation may be promoted in the case.

An object of the present disclosure is to provide a power storage device that can suppress promotion of heat generation in a case.

An object of the present disclosure is to provide a power storage device that can suppress promotion of heat generation in a case after gas is discharged through a pressure relief valve.

A power storage device according to one aspect of the present disclosure includes: a plurality of power storage stacks disposed to be arranged along one direction; a case that accommodates the plurality of power storage stacks; a pressure relief valve provided to the case; and a breathable membrane provided to the case, wherein each of the plurality of power storage stacks includes a plurality of power storage cells, the case includes a bottom wall supporting the plurality of power storage stacks, a peripheral wall surrounding the plurality of power storage stacks, and a top wall covering the plurality of power storage stacks, the pressure relief valve is provided on the top wall, and the breathable membrane is provided at a part of the bottom wall and the peripheral wall located below the pressure relief valve.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view schematically showing a power storage device in one embodiment of the present disclosure.

FIG. 2 is a perspective view schematically showing a state in which an upper cover is removed from the power storage device shown in FIG. 1.

FIG. 3 is a plan view schematically showing the state in which the upper cover is removed from the power storage device.

FIG. 4 is a cross sectional view taken along a line IV-IV in FIG. 3.

FIG. 5 is a cross sectional view taken along a line V-V in FIG. 3.

FIG. 6 is a plan view schematically showing a modification of disposition of a pressure relief valve and a breathable membrane.

FIG. 7 is a plan view schematically showing a modification of the disposition of the pressure relief valve and the breathable membrane.

FIG. 8 is a cross sectional view taken along a line VIII-VIII in FIG. 7.

FIG. 9 is a cross sectional view schematically showing a modification of an facing plate portion.

### DESCRIPTION OF THE PREFERRED EMBODIMENTS

An embodiment of the present disclosure will be described with reference to the drawings. It should be noted that, in the drawings referred to below, the same or corresponding members will be designated by the same reference numerals.

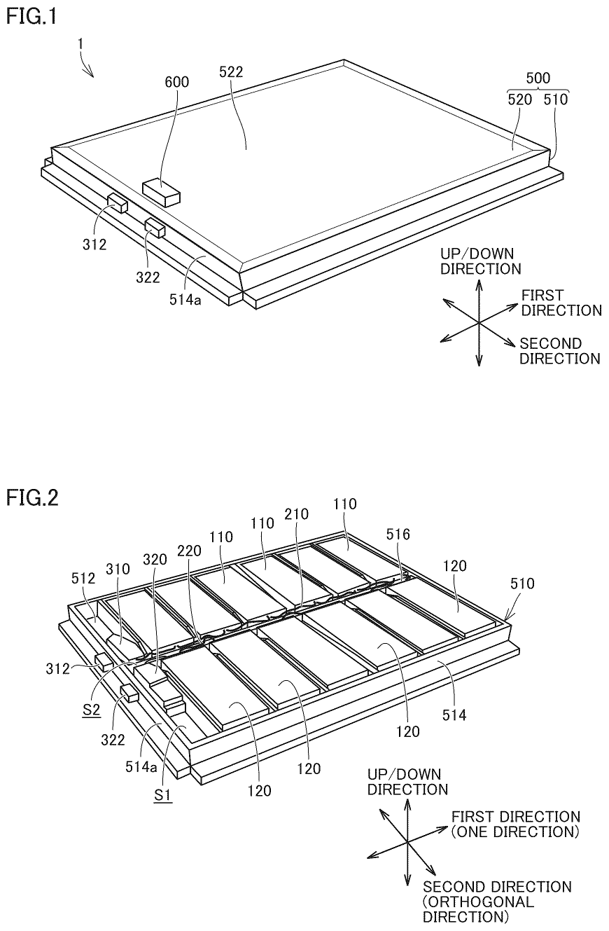

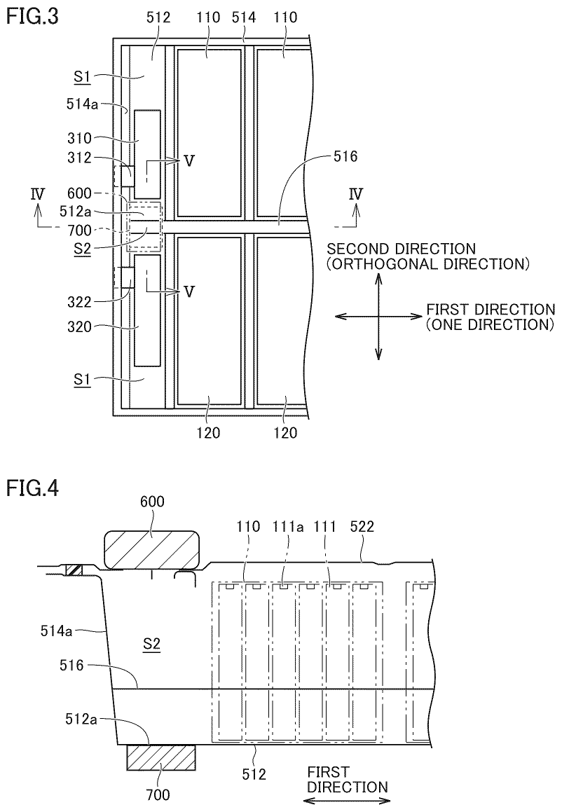

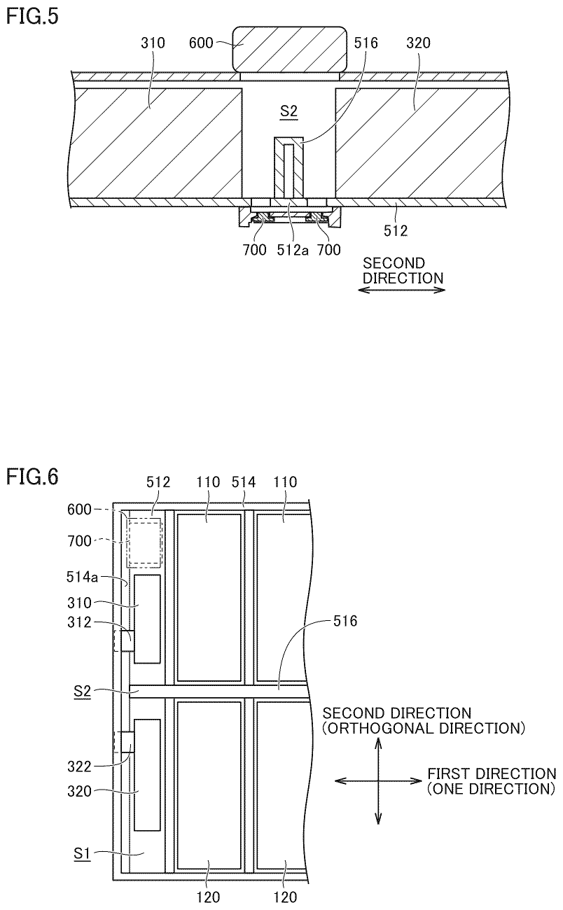

FIG. 1 is a perspective view schematically showing a power storage device in one embodiment of the present disclosure. FIG. 2 is a perspective view schematically showing a state in which an upper cover is removed from the power storage device shown in FIG. 1. FIG. 3 is a plan view schematically showing the state in which the upper cover is removed from the power storage device. FIG. 4 is a cross sectional view taken along a line IV-IV in FIG. 3. FIG. 5 is a cross sectional view taken along a line V-V in FIG. 3. A power storage device 1 is mounted on a bottom portion of a vehicle, for example.

As shown in FIGS. 1 to 5, power storage device 1 includes a plurality of first power storage stacks 110, a plurality of second power storage stacks 120, a first bus bar 210, a second bus bar 220, a first junction box 310, a second junction box 320, a case 500, a pressure relief valve 600, and a breathable membrane 700.

The plurality of first power storage stacks 110 are disposed to be arranged in a first direction. In the present embodiment, the plurality of first power storage stacks 110 include six first power storage stacks 110. However, the number of first power storage stacks 110 is not limited to six. Each first power storage stack 110 is formed in a rectangular solid shape elongated in a second direction orthogonal to both the first direction and an up/down direction. First power storage stack 110 is an example of the “power storage stack” in the present disclosure. Further, the first direction is an example of the “one direction” in the present disclosure, and the second direction is an example of the “orthogonal direction” in the present disclosure.

Each first power storage stack 110 includes a plurality of power storage cells 111 (see FIG. 4). The plurality of power storage cells 111 are disposed to be arranged in the first direction, for example. It should be noted that the plurality of power storage cells 111 may be disposed to be arranged in the second direction. Each power storage cell 111 is formed in a flat rectangular solid shape. As each power storage cell 111, a lithium ion battery may be used, for example. Each power storage cell 111 may be constituted by an all-solid-state battery using a solid electrolyte. As shown in FIG. 4, each power storage cell 111 includes a safety valve 111a provided on an upper surface of a casing of power storage cell 111.

The plurality of second power storage stacks 120 are disposed to face the plurality of first power storage stacks 110 in the second direction, and to be arranged in the first direction. In the present embodiment, the plurality of second power storage stacks 120 include six second power storage stacks 120. However, the number of second power storage stacks 120 is not limited to six. The configuration of each second power storage stack 120 is the same as the configuration of first power storage stack 110. Second power storage stack 120 is an example of the “other power storage stack” in the present disclosure.

First bus bar 210 connects a pair of first power storage stacks 110 adjacent to each other in the first direction. Second bus bar 220 connects a pair of second power storage stacks 120 adjacent to each other in the first direction. First bus bar 210 and second bus bar 220 are routed in a space between the plurality of first power storage stacks 110 and the plurality of second power storage stacks 120. It should be noted that, in FIG. 3, illustration of first bus bar 210 and second bus bar 220 is omitted.

First junction box 310 is disposed at a position facing the plurality of first power storage stacks 110 in the first direction. More specifically, first junction box 310 is disposed at a position facing first power storage stack 110 disposed on the outermost side in the first direction, of the plurality of first power storage stacks 110, in the first direction. First junction box 310 accommodates a relay, a fuse, and the like. First junction box 310 has a first connector 312. First connector 312 protrudes outward in the first direction.

Second junction box 320 is disposed at a position facing the plurality of second power storage stacks 120 in the first direction, and facing first junction box 310 in the second direction with a spacing therebetween. Second junction box 320 accommodates a relay, a fuse, and the like. Second junction box 320 has a second connector 322. Second connector 322 protrudes outward in the first direction.

Case 500 accommodates the plurality of first power storage stacks 110, the plurality of second power storage stacks 120, first bus bar 210, second bus bar 220, first junction box 310, and second junction box 320. Case 500 includes a one-side space S1 formed on one side of the plurality of first power storage stacks 110 and the plurality of second power storage stacks 120 in the first direction. Junction boxes 310 and 320 are disposed in one-side space S1. Case 500 has a lower case 510 and an upper cover 520.

Lower case 510 is opened upward. Lower case 510 has a bottom wall 512, a peripheral wall 514, and a partition portion 516.

Bottom wall 512 supports power storage stacks 110 and 120. As shown in FIGS. 3 to 5, bottom wall 512 includes an intermediate portion 512a located below an inter-box space S2 between first junction box 310 and second junction box 320. Inter-box space S2 is a portion of one-side space S1.

Peripheral wall 514 rises from a peripheral edge portion of bottom wall 512. Peripheral wall 514 surrounds the plurality of first power storage stacks 110 and the plurality of second power storage stacks 120. Peripheral wall 514 is formed in a substantially rectangular tube shape.

Peripheral wall 514 includes a side wall 514a facing power storage stacks 110 and 120 in the first direction. Side wall 514a faces power storage stacks 110 and 120 in the first direction with one-side space S1 being sandwiched therebetween. Side wall 514a extends along the second direction. Side wall 514a is inclined to be gradually spaced apart from power storage stacks 110 and 120 toward an upper side. However, side wall 514a may be orthogonal to bottom wall 512.

Partition portion 516 provides a partition between the plurality of first power storage stacks 110 and the plurality of second power storage stacks 120. Partition portion 516 has a shape extending along the first direction. The height of partition portion 516 is lower than the height of peripheral wall 514. As shown in FIG. 2, bus bars 210 and 220 are routed on partition portion 516.

Upper cover 520 and lower case 510 accommodate the plurality of first power storage stacks 110, the plurality of second power storage stacks 120, first bus bar 210, second bus bar 220, first junction box 310, and second junction box 320. A peripheral edge portion of upper cover 520 is fixed to an upper end portion of peripheral wall 514 by bolts or the like.

Upper cover 520 has a top wall 522. Top wall 522 faces bottom wall 512. Top wall 522 covers the plurality of first power storage stacks 110, the plurality of second power storage stacks 120, first bus bar 210, second bus bar 220, first junction box 310, and second junction box 320.

Pressure relief valve 600 is provided to case 500. Pressure relief valve 600 releases pressure in case 500. Pressure relief valve 600 opens when the pressure in case 500 becomes equal to or higher than a reference value. Pressure relief valve 600 is constituted by a check valve. Pressure relief valve 600 is provided on top wall 522 of upper cover 520. Pressure relief valve 600 is preferably provided at a part of top wall 522 above one-side space S1. In the present embodiment, pressure relief valve 600 is provided at a part of top wall 522 above inter-box space S2.

Breathable membrane 700 is provided to case 500. Breathable membrane 700 regulates the pressure in case 500 by allowing passage of a gaseous body between the inside of case 500 and the outside of case 500. Breathable membrane 700 is provided at a part of bottom wall 512 and peripheral wall 514 located below pressure relief valve 600. In the present embodiment, breathable membrane 700 is provided on bottom wall 512. The breathable membrane is preferably provided at a part of bottom wall 512 located below one-side space S1. Specifically, breathable membrane 700 is provided at intermediate portion 512a of bottom wall 512. Intermediate portion 512a is provided with a through hole, and breathable membrane 700 is attached to an outer surface of intermediate portion 512a to cover the through hole. As shown in FIGS. 3 to 5, at least a portion of breathable membrane 700 may underlie a projection plane of pressure relief valve 600. Entire breathable membrane 700 may underlie the projection plane of pressure relief valve 600.

In power storage device 1 described above, for example, when gas is generated from one power storage cell 111 and the internal pressure in case 500 becomes equal to or higher than a reference value, the gas is discharged from pressure relief valve 600 to the outside of case 500. On this occasion, a contained substance (so-called debris) in power storage cell 111 contained in the gas discharged from pressure relief valve 600 is deposited on breathable membrane 700 provided below pressure relief valve 600, and thus breathable membrane 700 is blocked. Accordingly, inflow of air into case 500 through breathable membrane 700 after the gas is discharged through pressure relief valve 600 is suppressed. Therefore, also when power storage cell 111 different from one power storage cell 111 (for example, power storage cell 111 adjacent to one power storage cell 111) generates heat, promotion of heat generation in case 500 caused by the inflow of the air into case 500 is suppressed.

In the following, modifications of the embodiment described above will be described.

### <First Modification>

As shown in FIG. 6, pressure relief valve 600 may be provided at a part of top wall 522 located above a space of one-side space S1 outside junction boxes 310 and 320 in the second direction. In this case, breathable membrane 700 is preferably provided at a position where at least a portion of breathable membrane 700 underlies the projection plane of pressure relief valve 600.

### <Second Modification>

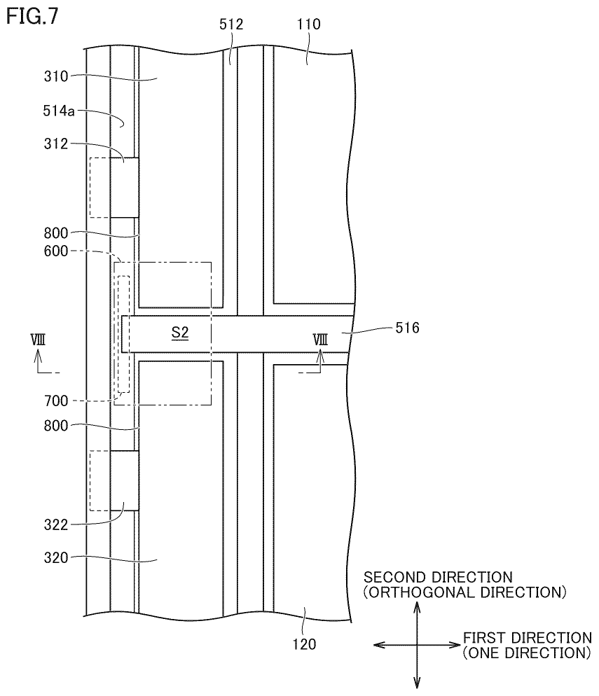

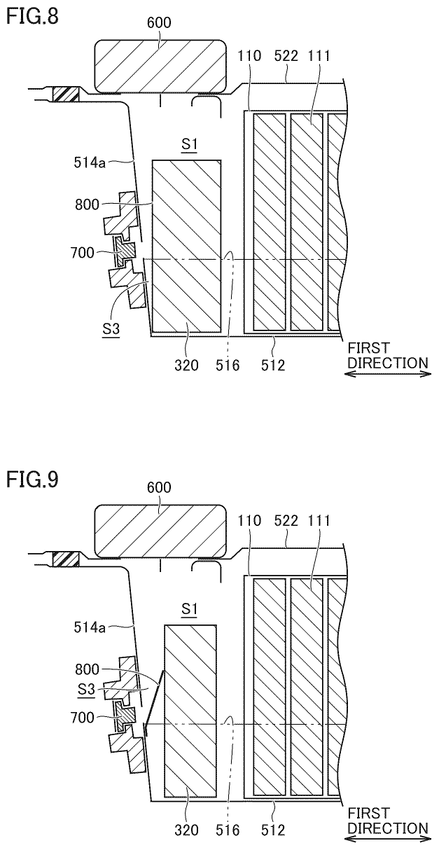

As shown in FIGS. 7 and 8, breathable membrane 700 may be provided on side wall 514a. In this case, preferably, power storage device 1 further includes a facing plate portion 800. Facing plate portion 800 is provided in case 500 and faces power storage stacks 110 and 120 in the first direction. Facing plate portion 800 forms a deposition space S3 (see FIG. 8) between facing plate portion 800 and side wall 514a. In this example, a part of each junction box 310, 320 facing side wall 514a constitutes facing plate portion 800.

In this aspect, breathable membrane 700 is blocked by deposition of the debris in deposition space S3.

### <Third Modification>

As shown in FIG. 9, facing plate portion 800 may be constituted by a member different from each junction box 310, 320. In this example, facing plate portion 800 is connected to a part of side wall 514a below a through hole formed at a position facing breathable membrane 700, by welding or the like.

It will be understood by a person skilled in the art that the exemplary embodiment described above is a specific example of the following aspects.

### [Aspect 1]

A power storage device comprising:
a plurality of power storage stacks disposed to be arranged along one direction;
a case that accommodates the plurality of power storage stacks;
a pressure relief valve provided to the case to release pressure in the case; and
a breathable membrane provided to the case to regulate the pressure in the case by allowing passage of a gaseous body between the inside of the case and the outside of the case, wherein
each of the plurality of power storage stacks includes a plurality of power storage cells,
the case includes
   a bottom wall supporting the plurality of power storage stacks,
   a peripheral wall surrounding the plurality of power storage stacks, and
   a top wall covering the plurality of power storage stacks,
the pressure relief valve is provided on the top wall, and
the breathable membrane is provided at a part of the bottom wall and the peripheral wall located below the pressure relief valve.

In this power storage device, a contained substance (so-called debris) in one power storage cell contained in gas generated from the power storage cell and discharged from the pressure relief valve is deposited on the breathable membrane provided below the pressure relief valve, and thus the breathable membrane is blocked. Accordingly, inflow of air into the case through the breathable membrane after the gas is discharged through the pressure relief valve and promotion of heat generation in the case caused thereby are suppressed.

### [Aspect 2]

The power storage device according to aspect 1, wherein the breathable membrane is provided on the bottom wall.

In this aspect, the debris is more effectively deposited on the breathable membrane.

### [Aspect 3]

The power storage device according to aspect 2, further comprising:
a plurality of other power storage stacks disposed to face the plurality of power storage stacks in an orthogonal direction orthogonal to both the one direction and an up/down direction, and to be arranged along the one direction;
a first junction box disposed at a position facing the plurality of power storage stacks in the one direction; and
a second junction box disposed at a position facing the plurality of other power storage stacks in the one direction, and facing the first junction box in the orthogonal direction with a spacing therebetween, wherein
the bottom wall includes an intermediate portion located below a space between the first junction box and the second junction box, and
the breathable membrane is provided at the intermediate portion.

In this aspect, since the debris is deposited between the first junction box and the second junction box, that is, on the intermediate portion, blockage of the breathable membrane is further promoted.

### [Aspect 4]

The power storage device according to aspect 1, further comprising a facing plate portion provided in the case and facing the plurality of power storage stacks in the one direction, wherein
the peripheral wall includes a side wall facing the plurality of power storage stacks in the one direction and inclined to be gradually spaced apart from the plurality of power storage stacks toward an upper side,
the breathable membrane is provided on the side wall, and
the facing plate portion forms a deposition space between the facing plate portion and the side wall.

In this aspect, the breathable membrane is blocked by deposition of the debris in the deposition space.

### [Aspect 5]

The power storage device according to aspect 4, further comprising a junction box disposed between the plurality of power storage stacks and the side wall, wherein
the junction box includes the facing plate portion.

In this aspect, since a portion of the junction box also serves as the facing plate portion, the number of components is reduced when compared with a case where a dedicated facing plate portion is provided.

### [Aspect 6]

The power storage device according to any one of aspects 1 to 5, wherein at least a portion of the breathable membrane underlies a projection plane of the pressure relief valve.

In this aspect, when the gas is discharged from the pressure relief valve, the debris dropped by impinging on the pressure relief valve is efficiently deposited on the breathable membrane.

Although the embodiment of the present disclosure has been described, it should be understood that the embodiment disclosed herein is illustrative and non-restrictive in every respect. The scope of the present disclosure is defined by the scope of the claims, and is intended to include any modifications within the scope and meaning equivalent to the scope of the claims.

What is claimed is:

1. A power storage device comprising:
a plurality of power storage stacks disposed to be arranged along one direction;
a case that accommodates the plurality of power storage stacks;
a pressure relief valve provided to the case; and
a breathable membrane provided to the case, wherein
each of the plurality of power storage stacks includes a plurality of power storage cells,
the case includes
a bottom wall supporting the plurality of power storage stacks,
a peripheral wall surrounding the plurality of power storage stacks, and
a top wall covering the plurality of power storage stacks,
the pressure relief valve is provided on the top wall, and
the breathable membrane is provided at a part of the bottom wall and the peripheral wall located below the pressure relief valve.

2. The power storage device according to claim 1, wherein the breathable membrane is provided on the bottom wall.

3. The power storage device according to claim 2, further comprising:
a plurality of other power storage stacks disposed to face the plurality of power storage stacks in an orthogonal direction orthogonal to both the one direction and an up/down direction, and to be arranged along the one direction;
a first junction box disposed at a position facing the plurality of power storage stacks in the one direction; and
a second junction box disposed at a position facing the plurality of other power storage stacks in the one direction, and facing the first junction box in the orthogonal direction with a spacing therebetween, wherein
the bottom wall includes an intermediate portion located below a space between the first junction box and the second junction box, and
the breathable membrane is provided at the intermediate portion.

4. The power storage device according to claim 1, further comprising a facing plate portion provided in the case and facing the plurality of power storage stacks in the one direction, wherein
the peripheral wall includes a side wall facing the plurality of power storage stacks in the one direction and inclined to be gradually spaced apart from the plurality of power storage stacks toward an upper side,
the breathable membrane is provided on the side wall, and
the facing plate portion forms a deposition space between the facing plate portion and the side wall.

5. The power storage device according to claim 4, further comprising a junction box disposed between the plurality of power storage stacks and the side wall, wherein
the junction box includes the facing plate portion.

6. The power storage device according to claim 1, wherein at least a portion of the breathable membrane underlies a projection plane of the pressure relief valve.
